(19) United States
(12) Patent Application Publication
(10) Pub. No.: US 2006/0291874 A1
(43) Pub. Date: Dec. 28, 2006

(54) Image forming apparatus having duplex printing capability and paper discharging method thereof

(75) Inventor: Kyu-chul Kyung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/399,650

(22) Filed: Apr. 7, 2006

(30) Foreign Application Priority Data
Jun. 24, 2005 (KR) 2005-55081

(51) Int. Cl. G03G 15/00

(52) U.S. Cl. 399/16; 399/21; 399/401

(57) ABSTRACT

An image forming apparatus having a duplex printing capability includes a paper discharging unit to discharge a printed sheet of paper to a paper discharge plate, and a duplex printing unit. The duplex printing unit includes a paper reversing unit to reverse a printing side of the one-side printed sheet of paper in a duplex print mode and includes a paper transport passage separated from the paper discharging unit, and a transport direction switcher to switch a paper transport direction between the paper discharging unit and paper reversing unit, whereby the sheet of paper is transported towards either the paper discharging unit or the paper reversing unit based on a sensed quantity of sheets of paper discharged to the paper discharge plate, and discharging the sheet of paper through the paper reversing unit where the sensed quantity of sheets of paper is greater than or equal to a predetermined value.

### CROSS-REFERENCE TO RELATED APPLICATIONS

This application claims the benefit of Korean Patent Application No. 2005-55081, filed Jun. 24, 2005, in the Korean Intellectual Property Office, the disclosure of which is incorporated herein by reference.

### BACKGROUND OF THE INVENTION

1. Field of the Invention

Aspects of the invention relate to an image forming apparatus, such as a laser beam printer and copier. More particularly, aspects of the invention relate to an image forming apparatus having a duplex printing capability, wherein a paper discharging path is separated from a paper reversing passage of a duplex printing path for high speed printing and to a paper discharging method thereof.

2. Description of the Related Art

In recent years, user demand for high speed printing has continuously increased. To increase the speed of printing, an image forming apparatus having a duplex printing capability is configured to pick up a new sheet of paper while a printed sheet of paper is discharged. To this end, in the typical configuration of the image forming apparatus having a duplex printing capability, a paper discharging path for discharging a completely printed sheet of paper is separated from a paper reversing passage of a duplex printing path for reversing the printing side of a one-side printed sheet of paper.

FIG. 1 is a schematic sectional view of a conventional laser printer 1 having a duplex printing capability in which a paper discharging path is separated from a paper reversing passage of a duplex printing path. As shown in FIG. 1, the duplex printing laser printer 1 includes a paper feeding cassette 11 detachably mounted in a main body frame 10, a pickup/transport unit 6 for picking up and transporting a sheet of paper P loaded in the paper feeding cassette 11, an image forming unit 30 for forming an overlapped color, for example yellow, magenta, cyan and black, toner image on a photosensitive body 32, a transferring unit 35 for transferring the toner image formed on the photosensitive body 32 onto the sheet of paper P, a fixing unit 40 for heat-pressing the toner image transferred onto the sheet of paper P to fix the toner images, a paper discharging unit 50 for discharging the sheet of paper P having the toner image fixed by the fixing unit 40, and a duplex printing unit 80 for feeding back the one-side printed sheet of paper P to the transferring unit 35 and fixing unit 40 to print another image on the other side thereof.

Referring to FIG. 2, a description will be given of a printing operation of the duplex printing laser printer 1 of FIG. 1. First, a sheet of paper P is picked up from the paper feeding cassette 11 by a first pickup roller 7 or from a manual feed plate 20 by a first or second pickup roller 7 or 26 depending upon an operation of a paper detecting sensor (not shown) for manual paper feeding. The picked-up sheet of paper P is transported towards the transferring unit 35 by first and second transport rollers 27 and 31 along a transport guide frame 22 (operation S1).

While the sheet of paper P is transported towards the transferring unit 35, an electrostatic latent image is formed on the photosensitive body 32 by a laser beam from a laser scanning unit (hereinafter, referred to as LSU) 77, and toner is attached to the formed electrostatic latent image by developing rollers 47 of the developers 34, 36, 37 and 39, thereby developing the electrostatic latent image into a visible toner image.

The toner image formed on the photosensitive body 32 is transferred to an image transferring belt 36 of the transferring unit 35. The transferred toner image is transferred again by a transferring roller 38 onto one side, for example an upper side, of the sheet of paper P when the sheet of paper P is transported to the transferring unit 35 along the transport guide frame 22. The toner image transferred on the upper side of the sheet of paper P is fixed on the upper side thereof by a heating roller 41 and press roller 42 constituting the fixing unit 40 (operation S2).

The sheet of paper P passing between the heating roller 41 and press roller 42 sets a paper detecting sensor 44 located in the downstream direction of paper transportation of the press roller 42 to an ‘on’ state. At this time, a controller (not shown) determines whether the printer 1 is in a simplex mode (operation S3). Upon determining that the printer 1 is in the simplex mode, the controller is adapted to shift a transport direction switcher 54 to a first location to block a paper reversing passage C of a duplex printing path B, as shown in FIG. 1 (operation S11). As a result, the sheet of paper P is guided to a paper discharging path A by the transport direction switcher 54 along a discharge guide frame 23, and discharged through a discharge roller 62 and discharge backup roller 61 of the paper discharging unit 50 onto a paper discharge plate 67 (operation S12).

On the other hand, upon determining that the printer 1 is in the duplex mode, the controller is adapted to shift the transport direction switcher 54 to a second location to block the paper discharging path A (operation S5). As a result, the sheet of paper P is guided to the paper reversing passage C along a reversal guide frame 24, and transported through the paper reversing passage C to a reversal roller 71 and reversal backup roller 72 of a paper reversing unit 70 (operation S6).

When the sheet of paper P approaches the reversal roller 71 and reversal backup roller 72, a reversal detection sensor 45 is set to an ‘on’ state. After the rear end of the sheet of paper P passes the reversal detection sensor 45, the reversal detection sensor 45 is set to an ‘off’ state again and adapted to generate an ‘off’ signal (operation S7). The controller controls the reversal roller 71 to rotate in the opposite direction in response to the ‘off’ signal from the reversal detection sensor 45 (operation S8). As a result, the sheet of paper P is not discharged out of the printer 1 but inserted into a back transport guide frame 25 constituting a back transport passage D of the duplex printing path B.

The sheet of paper P inserted into the back transport guide frame 25 is transported through first, second and third back transport rollers 74, 75 and 76 along the back transport passage D and again through the first and second transport rollers 27 and 31 back to the transferring unit 35 (operation S9), where another image is printed on the other side, namely the lower side, of the sheet of paper P in the same manner as described before (operation S10). The two-side printed sheet of paper passing the paper detecting sensor 44 sets the paper detecting sensor 44 to an ‘on’ state, generating an ‘on’ signal.

At this time, in response to the ‘on’ signal from the paper detecting sensor 44, the controller shifts the transport direction switcher 54 to the first location to block the paper reversing passage C (operation S11). As a result, the sheet of paper P is guided to the paper discharging path A by the transport direction switcher 54 along the discharge guide frame 23, and discharged using the discharge roller 62 and discharge backup roller 61 onto the paper discharge plate 67 (operation S12). Afterwards, the controller determines whether a new page to be printed is present. Where a new page is present, operations S1 to S12 are repeated. Otherwise, the printing operation comes to an end.

In the conventional duplex printing laser printer 1 of FIG. 1, the paper discharging path A is separated from the paper reversing passage C of the duplex printing path B. Thus a new sheet of paper P can be picked up while a one and/or two-side printed sheet of paper P is being discharged out in a simplex and/or duplex printing mode, permitting high speed printing.

However, in the conventional duplex printing laser printer 1, a printed sheet of paper is always discharged through the paper discharging path A onto the paper discharge plate 67 regardless of a simplex or duplex printing mode. When a large number of pages are printed or new sheets of paper P are printed in the state where sheets of paper P printed first by another user remain on the paper discharge plate 67, printed sheets of paper P can be piled up to a paper discharge exit 63 through which a printed sheet of paper P is discharged. Consequently, the printed sheet of paper P being discharged through the paper discharging path A can be interrupted as a result of the already printed sheets of paper P piled on the paper discharge plate 67.

Where a printed sheet of paper P is interrupted while being discharged through the paper discharging path A, the printed sheet of paper P may not be neatly aligned on the paper discharge plate 67, and can be scattered around or pushed out of the paper discharge plate 67, such as to the floor. In a severe interruption, where a printed sheet of paper P cannot be discharged through the paper discharging path A to the paper discharge plate 67, a paper jam occurs.

### SUMMARY OF THE INVENTION

An aspect of the present invention is to address the above and/or other problems and/or disadvantages and to provide the below described and/or other advantages. Accordingly, an aspect of the present invention is to provide an image forming apparatus having a duplex printing capability and a paper discharging method, wherein a printed sheet of paper is discharged through a paper reversing passage of a duplex printing path where the printed sheet of paper cannot be discharged through a paper discharging path.

According to an embodiment of the invention, there is provided an image forming apparatus having a duplex printing capability, including: a paper discharging unit to discharge a printed sheet of paper to a paper discharge plate, a duplex printing unit, the duplex printing unit including a paper reversing unit to reverse a printing side of the one-side printed sheet of paper in a duplex print mode, a paper transport passage separated from the paper discharging unit, and a transport direction switcher to switch a paper transport direction between the paper discharging unit and the paper reversing unit such that the sheet of paper is transported towards either the paper discharging unit or the paper reversing unit, and a discharge passage switching unit to sense the number or quantity of sheets of paper discharged through the paper discharging unit to the paper discharge plate and operating the transport direction switcher to thereby discharge the sheet of paper through the paper reversing unit to the paper discharge plate in response to the sensed number or quantity of sheets of paper being greater than or equal to a predetermined value.

The discharge passage switching unit includes a paper rate detecting sensor disposed at the paper discharge plate, the paper rate detecting sensor sensing the number or quantity of sheets of paper discharged through the paper discharging unit to the paper discharge plate, and a controller to control the transport direction switcher to move between a first location to guide the sheet of paper to the paper discharging unit and a second location to guide the sheet of paper to the paper reversing unit, on the basis of an on/off state of the paper rate detecting sensor.

The transport direction switcher can include a switching guide to selectively rotate between the first location and second location, the switching guide guiding paper transportation, and a solenoid connected with the switching guide, the solenoid selectively rotating the switching guide between the first location and second location. Also, the paper reversing unit can include reversal and reversal backup rollers to transport the sheet of paper towards the paper discharge plate, and a reversal detection sensor, disposed in an upstream direction of paper transportation of the reversal and reversal backup rollers, to sense passing of the sheet of paper to control reverse rotation timing of the reversal roller in a duplex print mode.

The controller can conclude that a paper jam has occurred and display a corresponding paper jam message on a display section when the transport direction switcher is controlled to move to the second location to guide the sheet of paper to the paper reversing unit and the reversal detection sensor is not in a corresponding on/off state indicating passage, or presence, of the sheet of paper after a predetermined time period. At this time, the predetermined time period is longer, or greater, than or equal to a time interval between a time when the sheet of paper sets a paper detecting sensor disposed in an upstream direction of paper transportation of the transport direction switcher to a corresponding on/off state indicating passage, or presence, of the sheet of paper and a time when the sheet of paper sets the reversal detection sensor to the corresponding on/off state indicating the passage of the sheet of paper.

In accordance with another aspect of the invention, a paper discharging method of an image forming apparatus having a duplex printing capability includes the operations of: measuring the number or quantity of sheets of paper discharged through a paper discharging unit to a paper discharge plate, and discharging a sheet of paper through a paper reversing unit of a duplex printing unit to the paper discharge plate where the measured number or quantity of sheets of paper is greater than or equal to a predetermined value.

The operation of measuring the number or quantity of sheets of paper discharged through a paper discharging unit to a paper discharge plate can be performed by the operation of testing, or determining an on/off state of a paper rate detecting sensor disposed adjacent to the paper discharge plate corresponding to the number or quantity of sheets of paper on the paper discharge plate.

The operation of discharging a sheet of paper through a paper reversing unit of a duplex printing unit to the paper discharge plate can be performed by the operations of guiding the sheet of paper to the paper reversing unit using a transport direction switcher of the duplex printing unit, and discharging the sheet of paper using a reversal roller of the paper reversing unit to the paper discharge plate.

Also, the operation of discharging a sheet of paper through a paper reversing unit of a duplex printing unit to the paper discharge plate can further include the operation of externally displaying a status message indicating that the sheet of paper is discharged using the reversal roller of the paper reversing unit.

In addition, the operation of discharging a sheet of paper through a paper reversing unit of a duplex printing unit to the paper discharge plate can further include the operations of detecting a paper jam caused by the sheet of paper guided to the paper reversing unit, and externally displaying a paper jam message where the sheet of paper has caused the paper jam. The operation of detecting a paper jam caused by the sheet of paper guided to the paper reversing unit can be performed by the operation of testing, or determining, an on/off state, indicating passage, or presence, or absence of a sheet of paper, of a reversal detection sensor installed adjacent to the paper reversing unit after a predetermined time period. Where the predetermined time period is greater than or equal to a time interval between a time when the sheet of paper sets a paper detecting sensor disposed in an upstream direction of paper transportation of the transport direction switcher to a corresponding on/off state indicating the passage of the sheet of paper and a time when the sheet of paper sets the reversal detection sensor to a corresponding on/off state indicating the passage of the sheet of paper.

The paper discharging method of an image forming apparatus having a duplex printing capability can further include the operation of discharging the sheet of paper through the paper discharging unit to the paper discharge plate where the measured number or quantity of sheets of paper is less than the predetermined value.

The operation of discharging the sheet of paper through the paper discharging unit to the paper discharge plate can be performed by the operations of guiding the sheet of paper to the paper discharging unit using a transport direction switcher of the duplex printing unit, and discharging the sheet of paper using a discharge roller of the paper discharging unit to the paper discharge plate.

While the invention is described in terms of paper, the invention, and aspects thereof, also applies to other types of media, apparatus and methods that can be suitable for simplex and/or duplex printing, such as film type media or media for overheads or transparencies, or other suitable type medium/media for printing, in addition to paper type media, in practice and applications of the invention. As such, references herein to paper also can correspond to other suitable medium or media, and can also apply to corresponding media and apparatus for other suitable media for simplex and duplex printing.

Additional aspects and/or advantages of the invention will be set forth in or are evident from the description which follows, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view of a conventional laser printer having a duplex printing capability;

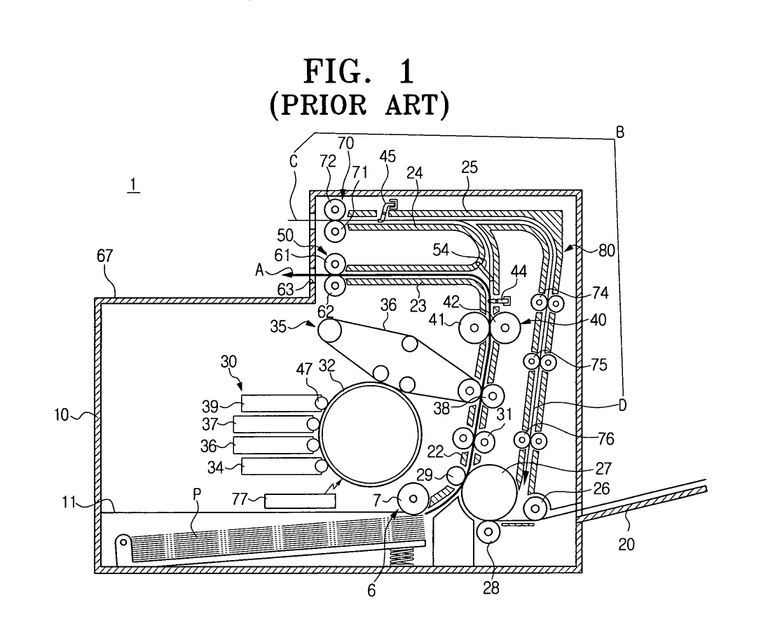

FIG. 2 is a flow chart illustrating a printing operation of the duplex printing laser printer of FIG. 1;

FIG. 3 is a schematic sectional view of a laser printer having a duplex printing capability according to an embodiment of the invention; and

FIG. 4 is a flow chart illustrating a printing operation of the duplex printing laser printer of FIG. 3 according to an aspect of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures, with well-known functions or constructions not being described in detail.

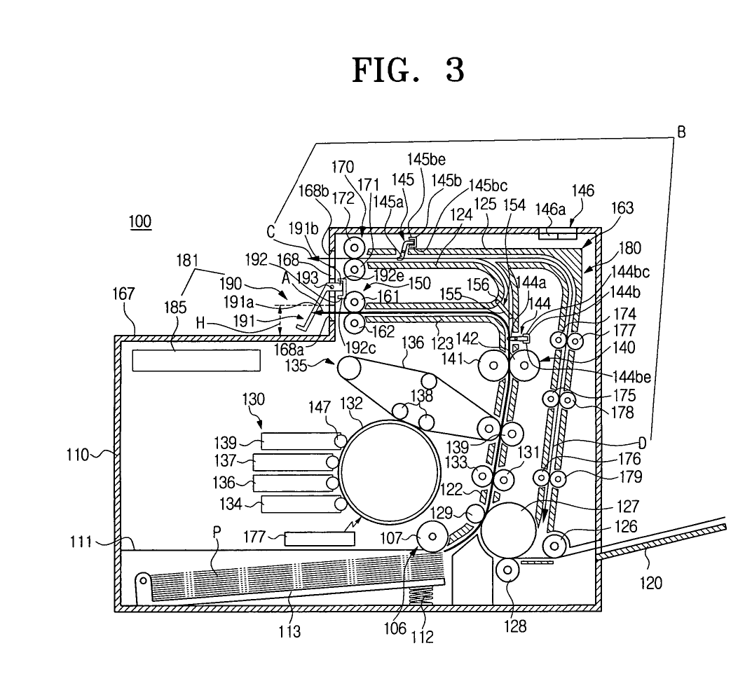

FIG. 3 is a schematic sectional view of an image forming apparatus 100 having a duplex printing capability according to an embodiment of the invention. The image forming apparatus 100 having a duplex printing capability according to an embodiment of the invention can be a duplex printing laser printer, as the image forming apparatus 100, which receives data from external devices, such as a personal computer, and prints the received data on sheets of paper.

The duplex printing laser printer 100 of FIG. 3 includes a paper feeding cassette 111, a pickup/transport unit 106, an image forming unit 130, a transferring unit 135, a fixing unit 140, a paper discharging unit 150, a duplex printing unit 180, and a discharge passage switching unit 181. The paper feeding cassette 111 is detachably mounted at a lower part of a main body frame 110, and supports sheets of paper P through a paper pressing plate 113 supported by an elastic spring 112, such that the sheets of paper P can correspondingly ascend and descend.

The pickup/transport unit 106 is installed on an upper part of the paper feeding cassette 111, and operates to pick up a single sheet from the sheets of paper P loaded on the paper feeding cassette 111, one at a time, and transport the picked up sheet of paper P. The pickup/transport unit 106 includes a first paper detecting sensor (not shown) for sensing loading of a sheet of paper P on the paper feeding cassette 111, a first pickup roller 107 for picking up a sheet of paper P from the paper feeding cassette 111, first transport and transport backup rollers 127 and 129 and second transport and transport backup rollers 131 and 133 to transport the picked up sheet of paper P to the transferring unit 135 along a transport guide frame 122 constituting a paper discharging path A.

The pickup/transport unit 106 further includes a manual feed plate 120 installed to project towards the front of the main body frame 110, a second paper detecting sensor (not shown) for sensing loading of a sheet of paper on the manual feed plate 120, and a second pickup roller 126 for picking up a sheet of paper from the manual feed plate 120 and transporting the picked up sheet of paper to a nip between the first transport roller 127 and a third transport backup roller 128. The manual feed plate 120, second paper detecting sensor, and second pickup roller 126 constitute a manual paper feeder.

The image forming unit 130 includes a drum-like photosensitive body 132 continuously rotated in one direction by a photosensitive body drive such as a motor (not shown). A charger (not shown), an LSU 177, four developers 134,136, 137 and 139 for containing yellow, magenta, cyan and black toner, respectively, and a transferring unit 135 are disposed in a rotating direction at predetermined locations around the periphery of the photosensitive body 132. The charger uniformly charges the surface of the photosensitive body 132 with electricity, such as a scorotron charger. The LSU 177 exposes the photosensitive body 132 in a line shape in a shaft direction to a laser beam radiated from a laser light source to form an electrostatic latent image.

Each of the developers 134, 136, 137 and 139 includes a developing roller 147 for attaching toner to the electrostatic latent image formed on the photosensitive body 132 to develop it into a corresponding toner image, a supplying roller (not shown) for supplying toner to the developing roller 147, and a thickness regulating member or blade (not shown) for regulating the thickness of a toner layer attached on the photosensitive body 132. The developing roller 147 of each of the developers 134, 136, 137 and 139 is fixed so as to maintain a constant distance, for example 0.2 mm, from the photosensitive body 132.

The transferring unit 135 electrostatically transfers the toner image formed on the photosensitive body 132 onto a sheet of paper P, and includes an image transferring belt 136 and first and second transferring rollers 138 and 139. The first transferring roller 138 is adapted to apply a predetermined transfer voltage to the image transferring belt 136 to thereby transfer the toner image from the photosensitive body 132 to the image transferring belt 136. The second transferring roller 139 is adapted to apply a predetermined transfer voltage to the sheet of paper P transported by the pickup/transport unit 106 to thereby further transfer the toner image from the image transferring belt 136 to the sheet of paper P. The fixing unit 140 acts to heat-press the toner image transferred to the sheet of paper P to fix the toner image. The fixing unit 140 includes a heating roller 141 for heating the toner image formed on the sheet of paper P, and a press roller 142 for pressing the sheet of paper P against the heating roller 141.

The paper discharging unit 150 acts to discharge the sheet of paper P having the toner image fixed by the fixing unit 140 through the paper discharging path A to an external paper discharge plate 167, and includes a discharge guide frame 123, a discharge roller 162 and discharge backup roller 161. The discharge guide frame 123 is disposed in the downstream direction of paper transportation of the fixing unit 140, and is included as a part of the paper discharging path A. The discharge roller 162 and discharge backup roller 161 are rotationally fixed to the discharge guide frame 123 in the vicinity of a first discharge exit 168a formed in a vertical wall 168 of the main body frame 110 near to the paper discharge plate 167.

The duplex printing unit 180 acts to reenter a one-side, namely an upper side, printed sheet of paper P printed through the fixing unit 140 to the transferring unit 135 to print another image on the other side, namely a lower side, of the sheet of paper P. The duplex printing unit 180 includes a transport direction switcher 154, a paper reversing unit 170, and a back transport guide 163.

The transport direction switcher 154 acts to guide a sheet of paper P to a paper reversing passage C of a duplex printing path B, namely providing guidance of a direction of paper transportation, in a duplex print mode and where printed sheets of paper P are piled up to the first discharge exit 168a. The transport direction switcher 154 is disposed at a location where the discharge guide frame 123 and reversal guide frame 124 meet in the downstream direction of paper transportation of the fixing unit 140. The transport direction switcher 154 includes a switching guide 155 and a solenoid 156, or other suitable switching device to provide guidance of the direction of paper transportation.

The switching guide 155 is located between the discharge guide frame 123 and reversal guide frame 124 so as to selectively rotate between a first location for guiding a sheet of paper P having a toner image fixed by the fixing unit 140 to the paper discharging path A of the discharge guide frame 123 and a second location for guiding the sheet of paper P to the paper reversing passage C of the reversal guide frame 124.

The solenoid 156 is operated to selectively rotate the switching guide 155 between the first location and second location in response to a control signal of a controller 185 generated by an ‘on’ signal from the third paper detecting sensor 144 detecting passage of a sheet of paper P. The controller 185 controls an overall operation of the duplex printing laser printer 100. The controller 185 typically includes a microprocessor electrically connected with drives of various devices in the duplex printing laser printer 100, and can be implemented with a circuit board fixed to an upper part of the main body frame 110. The controller 185 can also be any suitable device, such as a processor, microprocessor or an application specific integrated circuit (ASIC), with associated memory and software or programming, for controlling the operations of the image forming apparatus 100, such as the duplex printing laser printer 100. The third paper detecting sensor 144 is located in the downstream direction of paper transportation of the fixing unit 140 and includes a first sensing lever 144a and a first sensing section 144b. The first sensing lever 144a is arranged to rotate at the transport guide frame 122, and has a first end extending into a paper transport path, illustrated as extending into the paper discharging path A, for being operated by a sheet of paper P.

The first sensing section 144b can include an optical type sensor that includes a light emitting part 144be to emit a light beam and a light receiving part 144bc to receive the light beam from the light emitting part 144be. A second end of the first sensing lever 144a is positioned to move between the light emitting part 144be and light receiving part 144bc. Also, the third paper detecting sensor 144 can be any suitable optical, electro-optical, electro-mechanical or mechanical device or apparatus which senses the passage or presence of a sheet of paper P.

When a sheet of paper P passes the third paper detecting sensor 144, the first end of the first sensing lever 144a is pushed by the sheet of paper P to thereby rotate the first sensing lever 144a, and the second end of the first sensing lever 144a is thus moved to either a cut-off location between the light emitting part 144be and light receiving part 144bc or an open location separated from the cut-off location. As a result, the third paper detecting sensor 144 generates an ‘on’ signal or ‘off’ signal when a light beam from the light emitting part can reach or cannot reach the light receiving part in the first sensing section 144b correspondingly indicating the presence of, or passage of, or the absence of the sheet of paper P in the paper transport path.

The paper reversing unit 170 acts to reverse the printing side of an upper-side printed sheet of paper P, such that the lower-side of the upper-side printed sheet of paper P faces the transferring unit 135, and includes a reversal guide frame 124, reversal roller 171, reversal backup roller 172 and reversal detection sensor 145. The reversal guide frame 124 is connected with the discharge guide frame 123 in the downstream direction of paper transportation of the fixing unit 140, and includes the paper reversing passage C of the duplex printing path B. The reversal roller 171 and reversal backup roller 172 are rotationally fixed to the reversal guide frame 124 adjacent to a second discharge exit 168b formed in the vertical wall 168 of the main body frame 110.

The reversal detection sensor 145 acts to detect a paper jam and, under control of the controller 185, controls reverse rotation timing of the reversal roller 171 in a duplex print mode. The reversal detection sensor 145 is located at a back transport guide frame 125 above the reversal guide frame 124, and includes a second sensing lever 145a and a second sensing section 145b. The configurations and operations of the second sensing lever 145a and second sensing section 145b are substantially the same as those of the first sensing lever 144a and first sensing section 144b of the third paper detecting sensor 144. In this regard, the second sensing section 145b can include an optical type sensor that includes a light emitting part 145be to emit a light beam and a light receiving part 145bc for receiving the light beam from the light emitting part 145be. One end of the second sensing lever 145a is positioned to move between the light emitting part 145be and light receiving part 145bc. Also, the reversal detection sensor 145 can be any suitable optical, electro-optical, electromechanical or mechanical device or apparatus which senses the passage or presence of a sheet of paper P.

The controller 185 handles a paper jam and controls reverse rotation timing of the reversal roller 171 on the basis of the ‘on/off’ signal from the reversal detection sensor 145. For example, a time interval from a time when the front end of a sheet of paper P sets the third paper detecting sensor 144 to an ‘on’ state to a time when the front end of the sheet of paper P reaches the reversal detection sensor 145 can be experimentally measured, or determined, for an image forming apparatus 100, such as the duplex printing laser printer 100, according to aspects of the invention.

Where the front end of the sheet of paper P does not set the reversal detection sensor 145 to an ‘on’ state after a predetermined time, a little longer than or equal to the experimentally measured, or determined, time, for example, the controller 185 concludes that a paper jam has occurred and displays a prepared paper jam message on a liquid crystal display section 146a of an external control panel 146. Further, in a duplex print mode, when the rear end of a sheet of paper P passes the reversal detection sensor 145 and the reversal detection sensor 145 is set to an ‘off’ state, the controller 185 controls the reversal roller 171 to reversely rotate so that the sheet of paper P can enter into a back transport passage D of the back transport guide frame 125.

The back transport guide 163 is used to reenter an upper-side printed sheet of paper P to the transferring unit 135 to print another image on the lower side of the sheet of paper P. The back transport guide 163 includes the back transport guide frame 125, first, second and third back transport rollers 174, 175 and 176, and first, second and third back transport backup rollers 177, 178 and 179. The back transport guide frame 125 includes the back transport passage D of the duplex printing path B. The first, second and third back transport rollers 174, 175 and 176 and the first, second and third back transport backup rollers 177, 178 and 179 are rotationally arranged at predetermined intervals in the back transport guide frame 125.

The discharge passage switching unit 181 acts to prevent an additional sheet of paper P from being discharged through the paper discharging path A of the discharge guide frame 123, where sheets of paper P discharged on the paper discharge plate 167 are piled up to the height H of the paper discharging path A, or other predetermined height H, as a paper discharge height H, such as at or in relation to the first discharge exit 168a of the vertical wall 168, or as measured from the paper discharge plate 167, namely, piled higher, or greater, than or equal to the paper discharge height H or a predetermined height H, with an example of the paper discharge height or predetermined height H being indicated in FIG. 3. Thus, by the discharge passage switching unit 181 monitoring the paper discharge height H of the sheets of paper P discharged on the paper discharge plate 167, a sheet of paper P can be discharged through the first discharge exit 168a without being interrupted by sheets of paper P already piled on the paper discharge plate 167. The discharge passage switching unit 181 includes a paper rate detecting sensor 190 and the controller 185. The paper rate detecting sensor 190 acts to sense the number or quantity of sheets of paper P discharged through the paper discharging path A to the paper discharge plate 167, and includes a third sensing lever 191 and third sensing section 192.

The third sensing lever 191 includes a first end 191a extending towards the paper discharge plate 167 and a second end 191b extending towards the third sensing section 192, and is rotationally fixed to a support shaft 193 supported by the vertical wall 168. The third sensing section 192 is installed on a support bracket formed at the vertical wall 168, and is adapted to include a light emitting part 192e and a light receiving part 192c. The second end 191b of the third sensing lever 191 is arranged to move between the light emitting part 192e and light receiving part 192c of the third sensing section 192. When the first end 191a of the third sensing lever 191 is pushed up higher, or greater, than or equal to the paper discharge height H by sheets of paper P on the paper discharge plate 167, the second end 191b moves from a cut-off location between the light emitting part 192e and light receiving part 192c to an open location separated from the cut-off location, setting the third sensing section 192 to an ‘on’ state. In this regard, the third sensing section 192 can include an optical type sensor that includes the light emitting part 192e to emit a light beam and the light receiving part 192c for receiving the light beam from the light emitting part 192e. Also, the third sensing section 192 can be any suitable optical, electro-optical, electro-mechanical or mechanical device or apparatus which senses the paper discharge height H of the sheets of paper P on the paper discharge plate 167.

Therefore, in this regard, when the height of the sheets of paper P piled on the paper discharge plate 167 becomes higher, or greater, than or equal to the paper discharge height H, the first end 191a of the third sensing lever 191 is pushed up by the sheets of paper R As a result, the third sensing lever 191 is rotated around the support shaft 193 serving as the center of rotation, and the second end 191b is placed at the open location separated from the cut-off location of the third sensing section 192, setting the third sensing section 192 to an ‘on’ state.

On the other hand, when the height of sheets of paper P piled on the paper discharge plate 167 is lower than the paper discharge height H, the third sensing lever 191 is rotated around the support shaft 193 serving as the center of rotation owing to the weight of the first end 191a, and the second end 191b is placed at the cut-off location between the light emitting part 192e and light receiving part 192c of the third sensing section 192, setting the third sensing section 192 to an ‘off’ state. At this time, when a sheet of paper P is discharged through the first discharge exit 168a, the first end 191a of the third sensing lever 191 is pushed up by sheets of paper P. However, the second end 191b of the third sensing lever 191 is still placed at the cut-off location between the light emitting part and light receiving part, and the third sensing section 192 thus remains in the ‘off’ state.

On the basis of an ‘on/off’ operation of the paper rate detecting sensor 190, the controller 185 controls the switching guide 155 of the transport direction switcher 154 to switch between the first location to guide a one and/or two-side printed sheet of paper P to the discharge guide frame 123 and the second location to guide the one and/or two-side printed sheet of paper P to the reversal guide frame 124.

That is, where the paper rate detecting sensor 190 is in an ‘on’ state, the controller 185 concludes that discharged sheets of paper P are piled higher than or equal to the paper discharge height H on the paper discharge plate 167, and controls the solenoid 156 to position the switching guide 155 at the second location to discharge a one and/or two-side printed sheet of paper P. Consequently, the printed sheet of paper P is transported through the paper reversing passage C of the reversal guide frame 124 to the paper reversing unit 170 and discharged through the second discharge exit 168b formed in the vertical wall 168 of the main body frame 110.

Where the paper rate detecting sensor 190 is in an ‘off’ state, the controller 185 concludes that the discharged sheets of paper P are not piled higher, or greater, than or equal to the paper discharge height H on the paper discharge plate 167, and the controller 185 controls the solenoid 156 to position the switching guide 155 at the first location to discharge a one and/or two-side printed sheet of paper P. Consequently, the printed sheet of paper P is transported through the paper discharging path A of the discharge guide frame 123 to a nip between the discharge roller 162 and discharge backup roller 161 and discharged through the first discharge exit 168a formed in the vertical wall 168 of the main body frame 110.

Also, in the description of the duplex printing laser printer 100, although the transport direction switcher 154 is illustrated to operate in relation to the ‘on/off’ operation of the third paper detecting sensor 144 disposed in the downstream direction of paper transportation of the fixing unit 140, the invention is not limited in this regard. The transport direction switcher 154 can also be configured to operate in relation to an operation of other paper detecting sensor(s) disposed in the upstream direction of paper transportation of the first or third transport backup roller 129 or 128, for example.

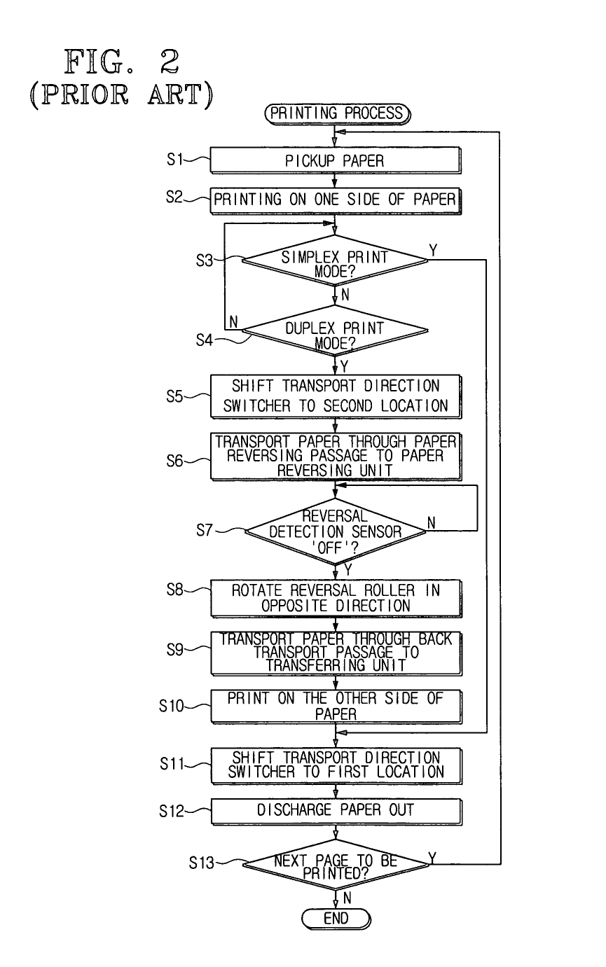

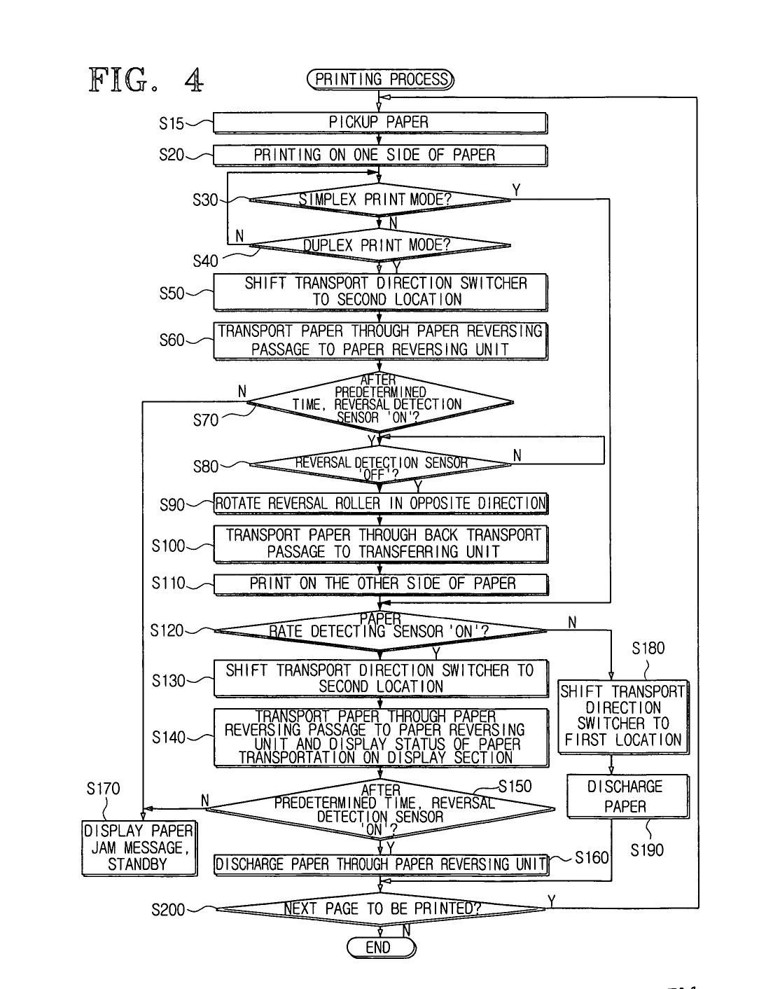

Referring to FIGS. 3 and 4, a detailed description will be given of a print operation of the duplex printing laser printer 100 having the above-described configuration according to an aspect of the invention. First, when a print command is input from a connected personal computer or the control panel 146, the controller 185 performs operations S15 to S110 in the same manner as operations S1 to S10 of the conventional laser printer 1 of FIG. 2, except that operation S70 is added.

After operation S60, to detect a paper jam, the controller 185 determines whether the reversal detection sensor 145 is set to an ‘on’ state by the front end of a sheet of paper P after a predetermined time period, for example, an experimentally measured time interval, or a predetermined time interval, from a time when the front end of the sheet of paper P sets the third paper detecting sensor 144 to an ‘on’ state to a time when the front end of the sheet of paper P reaches the reversal detection sensor 145 (operation S70). Where the reversal detection sensor 145 is determined to be not in an ‘on’ state after the predetermined time period at operation S70, the controller 185 concludes that a paper jam has occurred and displays a paper jam message on the display section 146a, and waits for user intervention (operation S170).

The controller 185 determines whether the paper rate detecting sensor 190 is in an ‘on’ state after it is determined at operation S30 that the sheet of paper P is printed on a one-side, namely the upper side, at operation S20 in a simplex print mode, or the sheet of paper P is printed on the other-side, namely the lower side, at operation S110 (operation S120).

Where it is determined at operation S120 that the paper rate detecting sensor 190 is in the ‘on’ state, the controller 185 controls the solenoid 156 to position the switching guide 155 at the second location while the one and/or two-side printed sheet of paper P is transported to the switching guide 155 of the transport direction switcher 154 (operation S130). Consequently, the printed sheet of paper P is transported through the paper reversing passage C of the reversal guide frame 124 to the paper reversing unit 170 and discharged through the second discharge exit 168b formed in the vertical wall 168 of the main body frame 110. The controller 185 then displays a status message, indicating that the printed sheet of paper P is being discharged through the paper reversing passage C to the paper reversing unit 170, on the liquid crystal display section 146a of the control panel 146 (operation S140).

To detect a paper jam while the printed sheet of paper P is discharged using the paper reversing unit 170, the controller 185 determines whether the reversal detection sensor 145 is in an ‘on’ state set by the front end of the sheet of paper P after the predetermined time period, for example, an experimentally measured time interval, or a predetermined time interval, from a time when the front end of the sheet of paper P sets the third paper detecting sensor 144 to an ‘on’ state to a time when the front end of the sheet of paper P reaches the reversal detection sensor 145 (operation S150).

Where the reversal detection sensor 145 is determined to be not in the ‘on’ state after the predetermined time period at operation S150, the controller 185 concludes that a paper jam has occurred and displays the paper jam message on the display section 146a, and waits for user intervention (operation S170). However, where the reversal detection sensor 145 is determined to be in the ‘on’ state within the predetermined time period at operation S150, the controller 185 concludes that a paper discharging operation is in a normal working condition, and controls the reversal roller 171 to keep on rotating, thereby discharging the printed sheet of paper P through the second discharge exit 168b to the paper discharge plate 167 (operation S160).

On the other hand, where it is determined at operation S120 that the paper rate detecting sensor 190 is in the ‘off’ state, the controller 185 controls the solenoid 156 to position the switching guide 155 at the first location while the one and/or two-side printed sheet of paper P is transported to the switching guide 155 of the transport direction switcher 154 (operation S180). Consequently, the printed sheet of paper P is transported through the paper discharging path A of the discharge guide frame 123 to a nip between the discharge roller 162 and discharge backup roller 161 of the paper discharging unit 150, and is discharged through the first discharge exit 168a to the paper discharge plate 167 (operation S190).

Afterwards, the controller 185 determines whether any new page of a sheet of paper P to be printed is present (operation S200). Where a new page of a sheet of paper P is present, operations S10 to S190 are repeated. Otherwise, the printing process comes to an end.

As apparent from the above description, the invention provides an image forming apparatus having a duplex printing capability and a paper discharging method, where a printed sheet of paper cannot be discharged through a paper discharging path of a paper discharging unit as a result of discharged sheets of paper already piled higher than or equal to a predetermined discharge height on a paper discharge plate, the printed sheet of paper is discharged through a paper reversing passage of a paper reversing unit. Accordingly, a printed sheet of paper to be discharged to the paper discharge plate is not interrupted by discharged sheets of paper already piled on the paper discharge plate. Therefore, printed sheets of paper can be neatly aligned on the paper discharge plate, and can avoid being scattered around and pushed out of the paper discharge plate to the floor. In addition, a paper jam due to an interrupted paper discharge operation can be prevented.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. An image forming apparatus, comprising:
a paper discharging unit to discharge a printed sheet of paper to a paper discharge plate;
a duplex printing unit, the duplex printing unit comprising:
a paper reversing unit to reverse a printing side of the one-side printed sheet of paper in a duplex print mode, with the paper reversing unit including paper transport passage separated from the paper discharging unit, and
a transport direction switcher to switch a paper transport direction between the paper discharging unit and the paper reversing unit, wherein the sheet of paper is selectively transported towards the paper discharging unit or the paper reversing unit; and
a discharge passage switching unit to sense a quantity of sheets of paper discharged through the paper discharging unit to the paper discharge plate and to operate the transport direction switcher to discharge the sheet of paper through the paper reversing unit to the paper discharge plate where the sensed quantity of sheets of paper is greater than or equal to a predetermined value.

2. The image forming apparatus of claim 1, wherein the discharge passage switching unit comprises:
a paper rate detecting sensor located adjacent to the paper discharge plate, the paper rate detecting sensor to sense the quantity of sheets of paper discharged through the paper discharging unit to the paper discharge plate; and
a controller to control the transport direction switcher to move between a first location to guide the sheet of paper to the paper discharging unit and a second location to guide the sheet of paper to the paper reversing unit, on the basis of an on/off state of the paper rate detecting sensor corresponding to the quantity of sheets of paper on the paper discharge plate.

3. The image forming apparatus of claim 2, wherein the transport direction switcher comprises:
a switching guide disposed to selectively rotate between the first location and the second location, and the switching guide to guide a direction of paper transportation; and
a solenoid connected with the switching guide, and the solenoid to rotate the switching guide between the first location and the second location.

4. The image forming apparatus of claim 3, wherein the paper reversing unit comprises:
reversal and reversal backup rollers to transport the sheet of paper towards the paper discharge plate, and
a reversal detection sensor located in an upstream direction of paper transportation of the reversal and reversal backup rollers, and the reversal detection sensor to sense passing of the sheet of paper to control reverse rotation timing of the reversal roller in a duplex print mode.

5. The image forming apparatus of claim 4, wherein:
the controller determines that a paper jam has occurred and displays a corresponding paper jam message on a display section, where the transport direction switcher is controlled to move to the second location to guide the sheet of paper to the paper reversing unit and the reversal detection sensor is not in a corresponding on/off state indicating passage of the sheet of paper after a predetermined time period.

6. The image forming apparatus of claim 5, further comprising:
a paper detecting sensor located in an upstream direction of paper transportation of the transport direction switcher, and
wherein the predetermined time period is a time period greater than or equal to a time interval between a time when the sheet of paper sets the paper detecting sensor located in the upstream direction of paper transportation of the transport direction switcher to a corresponding on/off state indicating passage of the sheet of paper and a time when the sheet of paper sets the reversal detection sensor to the corresponding on/off state indicating passage of the sheet of paper.

7. A paper discharging method of an image forming apparatus having a duplex printing capability, comprising:
measuring a quantity of sheets of paper discharged through a paper discharging unit to a paper discharge plate; and
discharging a sheet of paper through a paper reversing unit of a duplex printing unit to the paper discharge plate where the measured quantity of sheets of paper is greater than or equal to a predetermined value.

8. The paper discharging method of claim 7, wherein the measuring the quantity of sheets of paper discharged comprises:
determining an on/off state of a paper rate detecting sensor located adjacent to the paper discharge plate corresponding to the quantity of sheets of paper on the paper discharge plate.

9. The paper discharging method of claim 7, wherein the discharging the sheet of paper through the paper reversing unit comprises:
guiding the sheet of paper to the paper reversing unit using a transport direction switcher of the duplex printing unit; and
discharging the sheet of paper using a reversal roller of the paper reversing unit to the paper discharge plate.

10. The paper discharging method of claim 9, wherein the discharging the sheet of paper through the paper reversing unit further comprises:
externally displaying a status message indicating that the sheet of paper is discharged using the reversal roller of the paper reversing unit.

11. The paper discharging method of claim 9, wherein the discharging the sheet of paper through the paper reversing unit further comprises:
detecting a paper jam caused by the sheet of paper guided to the paper reversing unit; and
displaying a paper jam message where the sheet of paper has caused the paper jam.

12. The paper discharging method of claim 11, wherein the detecting the paper jam comprises:
determining an on/off state of a reversal detection sensor installed at the paper reversing unit after a predetermined time period, the on/off state indicating passage or absence of the sheet of paper.

13. The paper discharging method of claim 12, wherein the predetermined time period is a time period greater than or equal to a time interval between a time when the sheet of paper sets a paper detecting sensor located in an upstream direction of paper transportation of the transport direction switcher to a corresponding on/off state indicating passage of the sheet of paper and a time when the sheet of paper sets the reversal detection sensor to a corresponding on/off state indicating passage of the sheet of paper.

14. The paper discharging method of claim 7, further comprising:
discharging the sheet of paper through the paper discharging unit to the paper discharge plate where the measured quantity of sheets of paper is less than the predetermined value.

15. The paper discharging method of claim 14, wherein the discharging the sheet of paper through the paper discharging unit comprises:
guiding the sheet of paper to the paper discharging unit by a transport direction switcher of the duplex printing unit; and
discharging the sheet of paper by a discharge roller of the paper discharging unit to the paper discharge plate.

16. The paper discharging method of claim 15, wherein the measuring the quantity of sheets of paper discharged comprises determining an on/off state of a paper rate detecting sensor located adjacent to the paper discharge plate corresponding to the quantity of sheets of paper on the paper discharge plate.

17. The paper discharging method of claim 15, wherein the discharging the sheet of paper through the paper reversing unit comprises:
guiding the sheet of paper to the paper reversing unit using the transport direction switcher of the duplex printing unit; and
discharging the sheet of paper using a reversal roller of the paper reversing unit to the paper discharge plate.

18. The paper discharging method of claim 17, wherein the discharging the sheet of paper through the paper reversing unit further comprises:
externally displaying a status message indicating that the sheet of paper is discharged using the reversal roller of the paper reversing unit.

19. The paper discharging method of claim 17, wherein the discharging the sheet of paper through the paper reversing unit further comprises:
detecting a paper jam caused by the sheet of paper guided to the paper reversing unit; and
displaying a paper jam message where the sheet of paper has caused the paper jam.

20. The paper discharging method of claim 19, wherein the detecting the paper jam comprises:
determining an on/off state of a reversal detection sensor installed at the paper reversing unit after a predetermined time period, the on/off state indicating passage or absence of the sheet of paper.

21. The paper discharging method of claim 20, wherein the predetermined time period is a time period greater than or equal to a time interval between a time when the sheet of paper sets a paper detecting sensor located in an upstream direction of paper transportation of the transport direction switcher to a corresponding on/off state indicating passage of the sheet of paper and a time when the sheet of paper sets the reversal detection sensor to a corresponding on/off state indicating passage of the sheet of paper.

22. The paper discharging method of claim 21, wherein the predetermined value corresponds to a paper discharge height of the sheets of paper on the paper discharge plate.

23. The paper discharging method of claim 15, wherein the predetermined value corresponds to a paper discharge height of the sheets of paper on the paper discharge plate.

24. The paper discharging method of claim 14, wherein the predetermined value corresponds to a paper discharge height of the sheets of paper on the paper discharge plate.

25. The paper discharging method of claim 7, wherein the predetermined value corresponds to a paper discharge height of the sheets of paper on the paper discharge plate.

26. The paper discharging method of claim 8, wherein the predetermined value corresponds to a paper discharge height of the sheets of paper on the paper discharge plate.

27. A discharging method of an image forming apparatus, comprising:
measuring a quantity of a medium discharged to a discharge plate of the image forming apparatus; and
discharging a sheet of the medium through a reversing unit of a duplex printing unit of the image forming apparatus to the discharge plate where the measured quantity of sheets of the medium is greater than or equal to a predetermined value.

28. The discharging method of claim 27, wherein measuring the quantity of sheets of the medium discharged comprises determining an on/off state of a rate detecting sensor located adjacent to the discharge plate corresponding to the quantity of sheets of the medium on the discharge plate.

29. The discharging method of claim 28, wherein the predetermined value corresponds to a discharge height of the sheets of the medium on the discharge plate.

30. The discharging method of claim 29, further comprising:
discharging the sheet of the medium through a discharging unit, other than the reversing unit of the duplex printing unit, to the discharge plate where the measured quantity of sheets of the medium is less than the predetermined value.

31. The discharging method of claim 28, further comprising:
discharging the sheet of the medium through a discharging unit, other than the reversing unit of the duplex printing unit, to the discharge plate where the measured quantity of sheets of the medium is less than the predetermined value.

32. The discharging method of claim 31, wherein the predetermined value corresponds to a discharge height of the sheets of the medium on the discharge plate.

33. The discharging method of claim 27, further comprising:
discharging the sheet of the medium through a discharging unit, other than the reversing unit of the duplex printing unit, to the discharge plate where the measured quantity of sheets of the medium is less than the predetermined value.

34. The discharging method of claim 33, wherein the predetermined value corresponds to a discharge height of the sheets of the medium on the discharge plate.

35. The discharging method of claim 27, wherein the predetermined value corresponds to a discharge height of the sheets of the medium on the discharge plate.

36. An image forming apparatus, comprising:
a discharging unit to discharge a printed sheet of a medium to a discharge plate;
a duplex printing unit, comprising:
a reversing unit to reverse a printing side of the one-side printed sheet of the medium in a duplex print mode, and
a transport direction switcher to switch a transport direction between the discharging unit and the reversing unit, wherein the sheet of the medium is selectively transported towards the discharging unit or the reversing unit; and
a discharge passage switching unit to sense the quantity of sheets of the medium discharged through the discharging unit to the discharge plate and to operate the transport direction switcher to discharge the sheet of the medium through the reversing unit to the discharge plate where the sensed quantity of sheets of the medium is greater than or equal to a predetermined value.

37. The image forming apparatus of claim 36, wherein the discharge passage switching unit comprises:
a rate detecting sensor located adjacent to the discharge plate, the rate detecting sensor to sense the quantity of sheets of the medium discharged through the discharging unit to the discharge plate; and
a controller to control the transport direction switcher to move between a first location to guide the sheet of the medium to the discharging unit and a second location to guide the sheet of the medium to the reversing unit, on the basis of an on/off state of the rate detecting sensor corresponding to the quantity of sheets of the medium on the discharge plate.

38. The image forming apparatus of claim 37, wherein the predetermined value corresponds to a discharge height of the sheets of the medium on the discharge plate.

39. The image forming apparatus of claim 36, wherein the predetermined value corresponds to a discharge height of the sheets of the medium on the discharge plate.

40. The image forming apparatus of claim 1, wherein the predetermined value corresponds to a discharge height of the sheets of paper on the paper discharge plate.

41. The image forming apparatus of claim 2, wherein the predetermined value corresponds to a discharge height of the sheets of paper on the paper discharge plate.

42. The image forming apparatus of claim 3, wherein the predetermined value corresponds to a discharge height of the sheets of paper on the paper discharge plate.
